(19) United States
(12) Patent Application Publication
(10) Pub. No.: US 2024/0369117 A1
(43) Pub. Date: Nov. 7, 2024

(54) ACTUATOR SUBASSEMBLY AND METHOD FOR PRODUCING AN ACTUATOR SUBASSEMBLY

(71) Applicant: ZF Active Safety US Inc., Livonia, MI (US)

(72) Inventor: Galus Chelaidite, South Lyon, MI (US)

(21) Appl. No.: 18/310,585

(22) Filed: May 2, 2023

(51) Int. Cl. F16D 65/18; B60T 11/00; F16D 65/00

(52) U.S. Cl. CPC F16D 65/18; B60T 11/00; F16D 65/0068; F16D 2055/0016; F16D 2125/40; F16D 2127/00; F16D 2250/0084

(57) ABSTRACT

There is set out an actuator subassembly (10) for a vehicle brake, having a linearly displaceable, unilaterally open brake piston (20) which is used to apply a brake liner to a brake rotor, having a brake calliper unit (12), in which a receptacle (22) having a running face (24) for the brake piston (20) is provided, and having a rotation prevention member which has at least one axially extending groove (38) in the running face (24) and at least one rotation prevention element (32) and by means of which the brake piston (20) is guided in the brake calliper unit (12) in a rotationally secure manner when the rotation prevention element (32) is received in the groove (38). The rotation prevention member is constructed in such a manner that the brake piston (20) can be inserted in the receptacle in an axial direction during assembly of the actuator subassembly (10) together with the rotation prevention element (32) so that the rotation prevention element (32) is located in the groove (38) in a rotationally secure manner. Furthermore, a method for producing an actuator subassembly (10) is set out.

### TECHNICAL FIELD

The invention relates to an actuator subassembly for a vehicle brake and a method for producing an actuator subassembly.

### BACKGROUND

Actuator subassemblies for vehicle brakes generally have a linearly displaceable brake piston which is guided in a brake calliper unit and which serves to apply a brake liner to a brake rotor. To this end, for example, the brake piston is displaced by means of a spindle drive.

In order to translate a rotation of a spindle completely into a linear movement of the brake piston, the brake piston must be guided in the brake calliper unit in a rotationally secure manner.

In order to bring about a rotation prevention, generally an elongate recess, via which a circumferential face of the brake piston is accessible, is provided in the brake calliper unit. In known actuator subassemblies, after the brake piston is inserted into the brake calliper unit, a rotation prevention element is fitted to the brake piston via the recess in such a manner that the rotation prevention element is guided in the recess.

A disadvantage here is that the assembly of the rotation prevention element is relatively complex.

### SUMMARY

Therefore, an object of the present invention is to provide an actuator subassembly for a vehicle brake, in which rotation prevention can be brought about for the brake piston in a particularly simple manner.

This object is achieved according to the invention by an actuator subassembly for a vehicle brake, having a linearly displaceable, unilaterally open brake piston which is used to apply a brake liner to a brake rotor, having a brake calliper unit, in which a receptacle having a running face for the brake piston is provided, and having a rotation prevention member which has at least one axially extending groove in the running face and at least one rotation prevention element and by means of which the brake piston is guided in the brake calliper unit in a rotationally secure manner when the rotation prevention element is received in the groove. The rotation prevention member is constructed in such a manner that the brake piston can be inserted in the receptacle in an axial direction during assembly of the actuator subassembly together with the rotation prevention element so that the rotation prevention element is located in the groove in a rotationally secure manner. In this case, the axial direction corresponds to the movement direction of the brake piston if the brake piston is guided in the brake calliper unit.

By the brake piston being able to be inserted into the receptacle in an axial direction together with the rotation prevention element, the assembly of the brake piston is substantially simplified in comparison with known solutions. Before assembly in the brake calliper unit, the rotation prevention element can be fixed in a particularly simple manner to the brake piston because the circumferential face of the brake piston is freely accessible before the assembly. The recess in the brake calliper unit can also be dispensed with so that the production of the brake calliper unit is also simplified.

According to one embodiment, the at least one rotation prevention element is guided in an axially displaceable manner in the associated groove. In particular, a plurality of rotation prevention elements are provided, wherein a groove is associated with each rotation prevention element. By the at least one rotation prevention element being guided in the groove in an axially displaceable manner, the displaceability of the brake piston is not impaired by the rotation prevention member.

By a plurality of rotation prevention elements, which are particularly distributed over the brake piston at the circumference, being provided, a particularly stable guiding of the brake piston is ensured.

The groove can extend from the open side of the brake piston or begin with spacing from the open side. If the groove extends from the open side of the brake piston, the production of the groove is simplified. In specific terms, the groove can be milled in the brake piston from the open side of the brake piston. If the groove begins with spacing from the open side, the production is more complex because the accessibility to the groove is limited. However, the advantage is afforded by a groove which begins with spacing from the open side that the brake piston is better secured against slipping out with the rotation prevention element after being inserted into the receptacle.

For example, the rotation prevention element is a resilient element which can be compressed in a radial direction. The rotation prevention element can thereby be compressed radially inwardly during insertion into the receptacle. In particular, it is thereby possible to engage the brake piston in the receptacle with a correspondingly formed groove. Furthermore, the rotation prevention element can be pushed more readily via an annular seal, which is already arranged in the receptacle, or damage to the annular seal is prevented.

According to an alternative embodiment, the rotation prevention element is an element which is separate from the brake piston. The production of the rotation prevention element per se can thereby be simplified. Furthermore, in this case, the rotation prevention element can be made from a more resilient material than the brake piston, for example, from a spring steel.

Furthermore, the at least one rotation prevention element can be a ball which is separate from the brake piston. The use of balls as a rotation prevention element has the advantage that the friction between the brake piston and the running face or between the rotation prevention element and the running face is reduced.

For example, a plurality of balls which are arranged in a row are provided.

In another embodiment, the rotation prevention element is curved. In particular, the rotation prevention element is in the form of a curved leaf spring. As a result of the curved shape, the contact face between the rotation prevention element and the running face is reduced, which also ensures reduced friction.

In particular, only linear contact is present between the rotation prevention element and the running face in the case of a curved rotation prevention element.

The rotation prevention element which is separate from the brake piston can be retained magnetically on the brake piston. In this manner, the handling during assembly is simplified.

The brake calliper unit can have a brake calliper which has the running face or a brake calliper and a guide sleeve which is received therein and which has the running face. If a guide sleeve is present, the brake calliper unit is in at least two pieces. In the case of a two-piece production, the production of the individual members may be less complex in comparison with a one-piece production. With a running face which is present in the brake calliper, however, the assembly is simplified.

The brake calliper is, for example, a cast component.

The actuator subassembly comprises, for example, a ball screw having a rotatably supported recirculating ball screw, wherein the brake piston forms a spindle nut of the ball screw and is supported on the recirculating ball screw. By the brake piston itself forming the spindle nut, a compact construction type of the actuator subassembly is achieved.

The object is further achieved according to the invention by a method for producing an actuator subassembly according to the invention. In a first method step, a brake calliper unit having a receptacle for the brake piston and a brake piston having a rotation prevention element which is arranged on the circumferential face of the brake piston are provided. Subsequently, the brake piston is inserted into the receptacle in an axial direction together with the rotation prevention element.

As already described in connection with the actuator subassembly, the advantage is thereby afforded that the assembly of the actuator subassembly is particularly simple, in particular of the brake piston with the rotation prevention element.

### BRIEF DESCRIPTION OF THE DRAWINGS

Other advantages and features of the invention will be appreciated from the following description and the appended drawings. In the drawings:

FIG. 1 shows an exemplary actuator subassembly with a ball screw,

FIG. 2 shows a brake piston with a rotation prevention element in a guide sleeve for an actuator subassembly according to the invention as a perspective sectional illustration,

FIG. 3 shows an exploded illustration of the brake piston and the guide sleeve from FIG. 3,

FIG. 4 shows the rotation prevention element from FIGS. 2 and 3,

FIG. 5 shows a perspective sectioned illustration of a brake piston with an alternative rotation prevention element in a guide sleeve for an actuator subassembly according to the invention and

FIG. 6 shows an exploded illustration of the brake piston and the guide sleeve from FIG. 5.

### DESCRIPTION

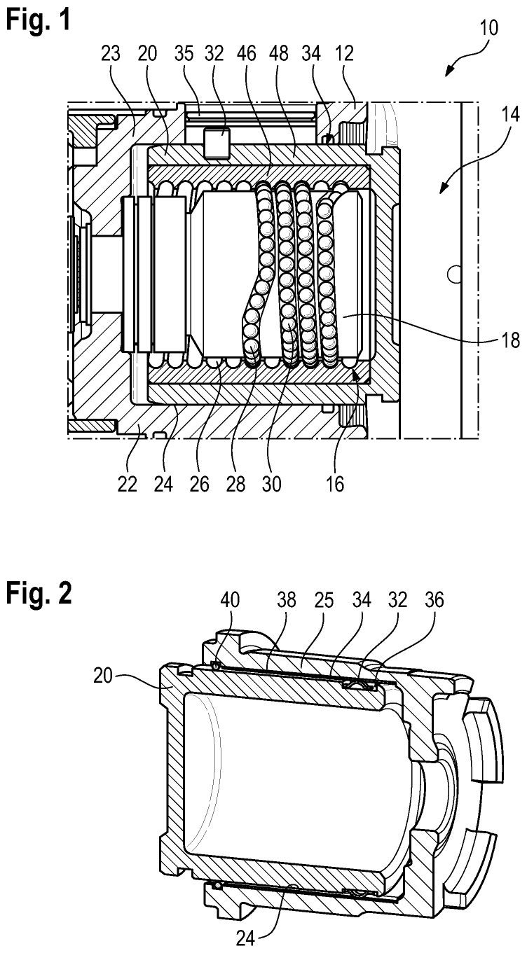

FIG. 1 shows an exemplary actuator subassembly 10 for a vehicle brake.

The actuator subassembly 10 comprises a brake calliper unit 12, in which an intermediate space 14 for a brake rotor is formed. The intermediate space 14 is illustrated only schematically in FIG. 1 for the sake of clarity.

Furthermore, the actuator subassembly 10 comprises a ball screw 16 having a rotatably supported recirculating ball screw 18, on which a unilaterally open brake piston 20 is supported. The brake piston 20 forms in particular a spindle nut of the ball screw 16.

A receptacle 22 having a running face 24 for the brake piston 20 is formed in the brake calliper unit 12. In specific terms, the brake calliper unit 12 has a brake calliper 23 which has the running face 24. In an alternative embodiment, the brake calliper unit 12 may have a brake calliper 23 and a guide sleeve 25 which is received therein (see, for example, FIG. 2) and which has the running face 24.

The brake piston 20 serves to apply a brake liner to the brake rotor.

An axial displacement of the brake piston 20 is brought about by rotation of the recirculating ball screw 18.

In specific terms, at least one thread turn 26 is formed on the circumferential face of the recirculating ball screw 18 and a corresponding thread turn 28 is formed on the internal face of the brake piston 20, wherein in the thread turns 26, 28 a large number of balls 30 are guided in such a manner that a rotation of the recirculating ball screw 18 brings about an axial displacement of the brake piston 20 along a rotation axis of the recirculating ball screw 18.

In the example illustrated in FIG. 1, the brake piston 20 is constructed in two pieces. However, a one-piece construction is also conceivable, as will be appreciated from the following Figures.

The brake piston 20 is guided in a rotationally secure manner on the brake calliper unit 12, in particular on the running face 24 of the receptacle 22.

To this end, in the embodiment a rotation prevention element 32 is fitted to a circumferential face 34 of the brake piston 20 which is guided in an axially extending groove 35 in the brake calliper unit 12.

The rotation prevention element 32 is, for example, a bolt.

The assembly of such a rotation prevention element 32 is relatively complex. To this end, the brake piston 20 first has to be inserted in the brake calliper unit 12 and orientated correctly before the rotation prevention element 32 is inserted from the exterior through the axially extending groove 35 and secured to the brake piston 20.

FIGS. 2 to 8 each illustrate different solutions in order to achieve a rotation prevention member according to the invention so that assembly of the brake piston 20 and the rotation prevention member is particularly simple.

The subassemblies illustrated in FIGS. 2 to 3 and 4 to 8 can to this end be integrated in the actuator subassembly 10 which is illustrated in FIG. 1.

The groove 35 illustrated in FIG. 1 can be dispensed with.

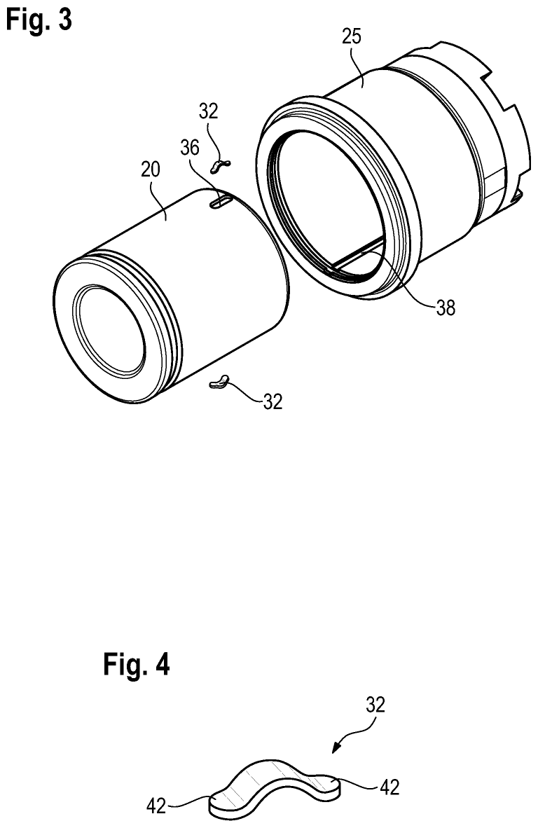

FIGS. 2 and 3 illustrate an embodiment of a brake piston 20, on which two rotation prevention elements 32 are arranged.

The brake piston 20 is constructed in one piece in the embodiment according to FIGS. 2 and 3.

The rotation prevention elements 32 are elements which are separate from the brake piston 20.

In order to be able to position the rotation prevention elements 32 in a defined position on the brake piston 20, a recess 36 is constructed in the circumferential face 34 of the brake piston 20 for each rotation prevention element 32, in which recess a rotation prevention element 32 is received in such a manner that the rotation prevention element 32 projects beyond the circumferential face 34 of the brake piston 20.

For simpler handling, the rotation prevention element 32 can be retained magnetically on the brake piston 20.

Two axially extending grooves 38 which are associated with the rotation prevention elements 32 are formed on the running face 24 which in the embodiment according to FIGS. 2 and 3 is formed on the guide sleeve 25.

The guide sleeve 25 is securely fixed in the brake calliper 23.

A rotation prevention element 32 is received in each axially extending groove 38 in such manner that the rotation prevention elements 32 are located in a rotationally secure manner in the grooves 38.

In specific terms, the rotation prevention elements 32 are guided in the grooves 38 in an axially displaceable manner.

The grooves 38 form together with the rotation prevention elements 32 a rotation prevention member of the brake piston 20.

The grooves 38 extend in the embodiment from an open end of the brake piston 20. However, it is also conceivable for the grooves 38 to begin with spacing from the open end of the brake piston 20.

The number of rotation prevention elements 32 and accordingly also the grooves 38 is not limited to two, a plurality of rotation prevention elements 32 may also be distributed over the brake piston 20 over the circumference, for example, three or four rotation prevention elements 32.

The rotation prevention elements 32 can be resiliently compressed in a radial direction.

During the assembly of the actuator subassembly 10, the brake piston 20 is inserted into the receptacle 22 in an axial direction together with the rotation prevention elements 32.

By the rotation prevention element 32 being able to be resiliently compressed in a radial direction, the rotation prevention element 32 can be moved during assembly over an annular seal 40 which is already arranged on the running face 24 before the assembly of the brake piston 20, in particular is received in a circumferential groove.

The rotation prevention element 32 is compressed radially inwardly during the assembly if it is moved over the annular seal 40. Damage to the annular seal 40 is thereby prevented.

FIG. 4 shows an individual rotation prevention element 32. FIG. 4 particularly clearly shows that the rotation prevention element 32 is curved. In more specific terms, the rotation prevention element 32 is a leaf spring.

In a manner adjacent to a curved portion, the rotation prevention element 32 has in the embodiment two laterally projecting support portions 42, with which the rotation prevention element 32 is supported on the brake piston 20.

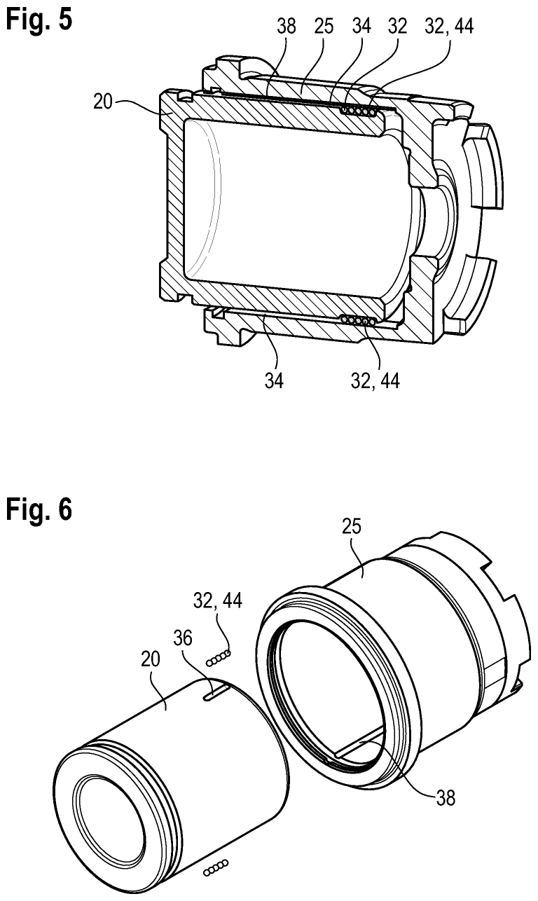

FIGS. 5 and 6 show a perspective sectioned view and an exploded view of a brake piston 20 with a plurality of rotation prevention elements 32 and a guide sleeve 25.

In comparison with FIGS. 2 and 3, the embodiment according to FIGS. 5 and 6 differs only as a result of the type of rotation prevention elements 32.

The rotation prevention elements 32 are formed by balls 44, wherein a plurality of balls 44, in the embodiment five balls 44, are arranged in a row. So to speak, a linear ball bearing is thereby formed.

The balls 44 are received in grooves 38 in a similar manner to the curved rotation prevention elements 32 according to FIGS. 2 to 4.

The balls 44 are not radially compressible unlike the curved rotation prevention elements 32.

In another alternative embodiment, which is not illustrated in the Figures for the sake of simplicity, the rotation prevention element 32 is produced by a rolling bearing.

1. Actuator subassembly (10) for a vehicle brake, having a linearly displaceable, unilaterally open brake piston (20) which is used to apply a brake liner to a brake rotor, having a brake calliper unit (12), in which a receptacle (22) having a running face (24) for the brake piston (20) is provided, and having a rotation prevention member which has at least one axially extending groove (38) in the running face (24) and at least one rotation prevention element (32) and by means of which the brake piston (20) is guided in the brake calliper unit (12) in a rotationally secure manner when the rotation prevention element (32) is received in the groove (38), wherein the rotation prevention member is constructed in such a manner that the brake piston (20) can be inserted in the receptacle in an axial direction during assembly of the actuator subassembly (10) together with the rotation prevention element (32) so that the rotation prevention element (32) is located in the groove (38) in a rotationally secure manner.

2. Actuator subassembly (10) according to claim 1, wherein the at least one rotation prevention element (32) is guided in an axially displaceable manner in the associated groove (38), in particular wherein a plurality of rotation prevention elements (32) are provided, wherein a groove (38) is associated with each rotation prevention element (32).

3. Actuator subassembly (10) according to claim 1, wherein the rotation prevention element (32) is a resilient element which can be compressed in a radial direction.

4. Actuator subassembly (10) according to claim 1, wherein the rotation prevention element (32) is an element which is separate from the brake piston (20).

5. Actuator subassembly (10) according to claim 1, wherein the at least one rotation prevention element (32) is a ball (44) which is separate from the brake piston (20).

6. Actuator subassembly (10) according to claim 1, wherein the rotation prevention element (32) is curved, in particular is in the form of a curved leaf spring.

7. Actuator subassembly (10) according to claim 1, wherein the rotation prevention element (32) is retained magnetically on the brake piston (20).

8. Actuator subassembly (10) according to claim 1, wherein the brake calliper unit (12) has a brake calliper (23) which has the running face (24) or a brake calliper (23) and a guide sleeve (25) which is received therein and which has the running face (24).

9. Actuator subassembly (10) according to claim 1, wherein the actuator subassembly (10) comprises a ball screw (16) having a rotatably supported recirculating ball screw (18), wherein the brake piston (20) forms a spindle nut of the ball screw (16) and is supported on the recirculating ball screw (18).

10. Method for producing an actuator subassembly (10) according to claim 1, comprising the following steps:
a brake calliper unit (12) having a receptacle (22) for the brake piston (20) and a brake piston (20) having a rotation prevention element (32) which is arranged on the circumferential face (34) of the brake piston (20) are provided, and
the brake piston (20) is inserted into the receptacle (22) in an axial direction together with the rotation prevention element (32).
